(19) United States
(12) Patent Application Publication
(10) Pub. No.: US 2010/0153572 A1
(43) Pub. Date: Jun. 17, 2010

(54) METHOD AND APPARATUS FOR IDENTIFYING AND SCHEDULING INTERNET RADIO PROGRAMMING

(75) Inventors: Ephraim Feig, San Diego, CA (US); Jie Ma, Itasca, IL (US)

Correspondence Address: Motorola, Inc.;Law Department, 1303 East Algonquin Road, 3rd Floor, Schaumburg, IL, 60196, US

(73) Assignee: Motorola, Inc., Schaumburg, IL (US)

(21) Appl. No.: 12/332,635

(22) Filed: Dec. 11, 2008

(51) Int. Cl. G06F 15/16; G06F 17/30

(52) U.S. Cl. 709/231; 707/E17.032

(57) ABSTRACT

A client device includes a network interface for receiving media content streamed over a network and a media player for rendering the media content. The client device also includes a content scheduling module configured to identify, schedule and access over the network selected media content items in accordance with a user profile. The content scheduling module is configured to search an online database to identify the selected media content that conforms to the user profile.

### FIELD OF THE INVENTION

The present invention relates generally to streaming media services, and more particularly to a method and apparatus for identifying, scheduling and accessing programming being streamed by Internet radio stations.

### BACKGROUND OF THE INVENTION

Internet radio stations currently operate by streaming either a “rebroadcast” of a live event (i.e., a concurrent multicast of the radio transmission content over the Internet), a broadcast of a live event only on the Internet, or a series of content items streamed with commercials and pre-recorded messages. Some stations broadcast over the air and over the Internet simultaneously, but there are increasingly many stations that are Internet only. Any person at any location in the world may receive such broadcasts with the proper Internet connection, audio equipment and, in some instances, registration and/or subscription. Sometimes, data may be downloaded in advance to a listener cache for faster playback later.

Since the term “Internet radio” is commonly used in the art, it will be used here as well. Typically, the content for the Internet radio station will include talk and music. It should be noted, however, that Internet radio is not limited to audio. An Internet radio broadcast may be accompanied by photos, graphics, text, and links, as well as interactivity, such as message boards and chat rooms. This allows a listener to do more than simply listen to a radio station. For example, a listener who hears an advertisement for a computer printer may order that printer through a link on the Internet radio broadcast website.

Internet radio programming offers a wide spectrum of broadcast genres, particularly in music. The cost of getting “on the air” is less for an Internet broadcaster, and Internet radio can appeal to “micro-communities” of listeners focused on special music or other interests. For quite some time, the only way to obtain radio broadcasts over the Internet was through a personal computer. However, it is generally envisioned that wireless connectivity will feed Internet broadcasts to car radios, PDAs, cell phones, dedicated Internet radios that in some cases emulate conventional AM and FM radios and the like.

Given the myriad of Internet radio stations and programming that are available, it can be difficult for a listener to find items of interest. Recently, a number of Internet radio services have come into existence that publish schedules of Internet radio stations, the programs they are or will be streaming, and the URLs at which the stations are located. These so-called Internet radio aggregators are generally on-line based services. A listener can search their published schedules by performing a keyword search through their browser to identify programs or other content items of interest.

One problem with the use of an Internet radio aggregator is that the listener must search for and access each individual program or content item that the listener wants to receive. That is, the listener cannot customize a schedule of programming so that, for instance, the listener automatically searches the available Internet radio stations to receive an hour of music performed by the Allman Brothers each day at 3 pm followed by a half hour of violin concertos.

### SUMMARY OF THE INVENTION

In accordance with one aspect of the invention, a client device includes a network interface for receiving media content streamed over a network and a media player for rendering the media content. The client device also includes a content scheduling module configured to identify, schedule and access over the network selected media content items in accordance with a user profile. The content scheduling module is configured to search an online database to identify the selected media content that conforms to the user profile.

In accordance with another aspect of the invention, a method is provided by which a user creates a customized schedule of Internet radio programming that will be automatically streamed to a user on a PC or other client device on which a content scheduling application is located. A user profile is received by the client device. The user profile specifies at least one criterion for identifying digital media content to be streamed to a user over a network by one or more media distribution systems. The client device searches an online database for selected media content that conforms to the user profile. The client device accesses the selected media content so that it is streamed to the user over the network in conformance with the user profile.

### BRIEF DESCRIPTION OF THE DRAWINGS

FIG. 1 shows a communication system in which media content is streamed by one or more media distribution systems to one or more client devices over a network such as the Internet.

FIG. 2 depicts one example of the client device shown in FIG. 1.

FIG. 3 shows one example of the functional elements that may be incorporated in a content scheduling module or application.

FIG. 4 shows one example of a menu of options that may be presented to the user by the user interface shown in FIG. 4.

FIG. 5 is a flowchart showing one example of method by which a user creates a customized schedule of Internet radio programming that will be automatically streamed to user on a PC or other client device on which a content scheduling application is located.

### DETAILED DESCRIPTION

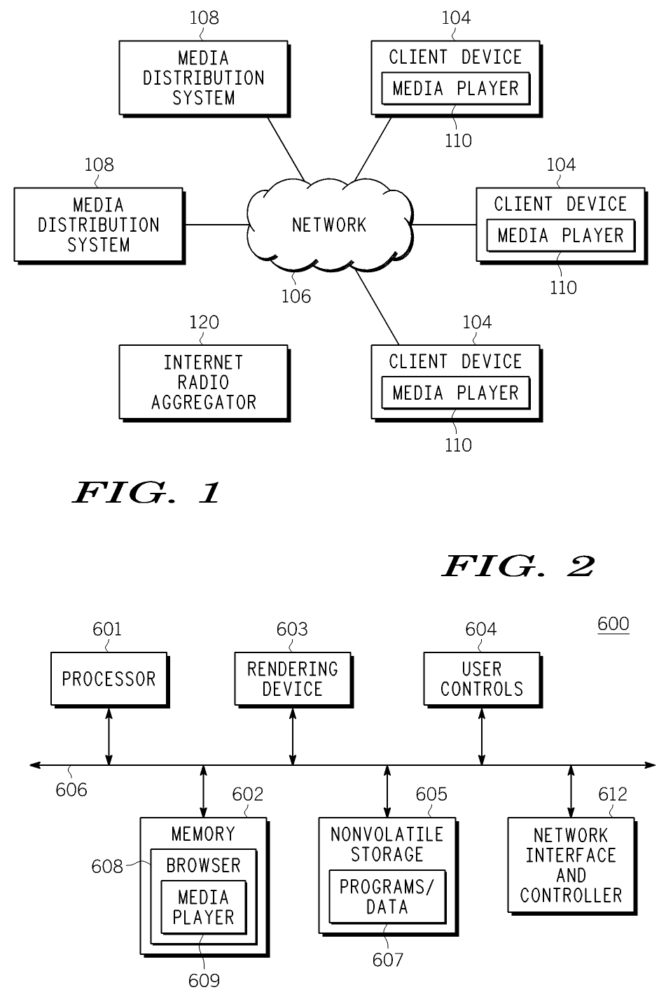

FIG. 1 shows a communication system in which media content is streamed by one or more media distribution systems 108 to one or more client devices 104 over a network such as the Internet. For purposes of illustration only and not as a limitation on the methods and systems described herein, the media distribution system 108 may be referred to as an Internet radio server that streams audio files and the client devices 104 may be referred to as Internet radios. An Internet radio server implements an Internet radio service that distributes one or more Internet radio stations to Internet radio receiver 104. The Internet radio stations may stream a wide variety of content, including music, sports, news, and so forth. “Radio,” as used herein, includes audio transmitted on selected channels within a video broadcasting system—e.g., music channels in a cable broadcast system.

More generally, examples of the types of media content that may be distributed by media distribution system 108 include: audio files (examples of which may include but are not limited to music files, audio news broadcasts, audio sports broadcasts, and audio recordings of books, for example); video files (examples of which may include but are not limited to video footage that does not include sound, for example); audio/video files (examples of which may include but are not limited to a/v news broadcasts, a/v sports broadcasts, feature-length movies and movie clips, music videos, and episodes of television shows, for example); and multimedia content (examples of which may include but are not limited to interactive presentations and slideshows, for example).

Prior to transmission, media distribution system 108 may encode the media content in any appropriate format. For instance, in the case of audio, the files may be encoded in a format such as MP3 (i.e., Motion Picture Experts Group Audio Layer 3) format, AAC (i.e., Advanced Audio Coding) format, RealAudio™ format, Quicktime™ format, and AVI (i.e., Audio Video Interleave) format, for example. Upon receipt, the streams/files may be decoded (using the appropriate decoder) and rendered by the client devices 104.

The client device 104 can be a personal computer, mobile phone, media center, set top box, a dedicated Internet radio or any device capable of supporting network communications. Each client device 104 includes a media player 1 10. The media player 110 is configured to communicate with the media distribution system 108 in order to receive and render the media content. In the case of Internet radio, examples of media players 110 include Windows Media Player™, RealPlayer™, etc.

FIG. 2 depicts one example of a client device 108. The client device 108 includes: at least one processor 601; memory 602, which may include read only memory (ROM), random access memory (RAM), cache memory, graphics card memory and the like; at least one rendering device 603 such as a display and/or a speaker; user controls 604, such as a keyboard and a mouse, trackball or similar device; and nonvolatile storage 605, such as a magnetic or optical disk drive (either local or on a remote network node); and network interface and controller 612. Network interface and controller 612 provides a connection to the Internet to receive the media content from the media distribution system 108. Network interface and controller may take the form of a conventional modem adapted for connection to a phone line in a public switch telephone network or a broadband modem for connection to a broadband network such as a cable or DSL network.

Processor 601, memory 602, rendering device 603, user controls 604, network interface and controller 612 and nonvolatile storage 605 are all coupled by an interconnect 606, such as one or more buses and/or a network connection, and are interoperable. Client device 600 is constructed and operates according known techniques, including a basic input/output system (BIOS), and operating system (OS), and one or more applications or user programs.

Those skilled in the art will recognize that, for simplicity and clarity, the full structure and operation of the client device is not being depicted or described herein. Instead, only so much of the client device is described as needed to facilitate an understanding of the systems and method being depicted and described herein. The remainder of the construction and operation of the client device may conform to any of the various implementations and practices known in the art.

Nonvolatile storage 605 conventionally contains a variety of user programs and user data 607, where the user programs are loaded into memory 602 for execution and the user data (e.g., cookies) may be employed in customizing the operation of such user programs. In the context of the present disclosure, programs 607 loaded into memory 602 include a browser 608 or similar application within which a media player 609 (e.g., Windows Media Player, Quicktime, RealPlayer™, or the like) operates as a plug-in.

Returning to FIG. 1, the communication system further includes an Internet media aggregator 120, which, in the case of Internet radio, is an Internet radio aggregator. Internet radio aggregator 120 gathers and publishes information regarding the media content being streamed by Internet radio servers 108. Such information may include information about a currently playing song such as the title, performing artist, album name, composer, genre and the like. The information may also include information about content other than songs. For example, if a talk show is playing on a particular Internet radio station, the information may include the name of the talk show, the name of a guest on the talk show that is being interviewed, etc. The Internet radio aggregator may also gather and publish similar information about past media content which have been streamed and/or future media content which is going to be streamed.

The Internet radio aggregator 120 publishes the aforementioned information so that it is searchable by client device 104 using, for instance, a web browser such as browser 608 shown in FIG. 2. In this way users can search for content they are interested in using keywords. The search results present the user with a list of content items being streamed by Internet radio servers 108 that match the search criteria. For each content item, the list may include an address (e.g., a URL) at which the content may be received. The station list may also include hyperlinks to the content. Current examples of Internet radio aggregators include, for example, Live365, Pandora, RadioLocator, Batanga, MyRedLounge, Jango, LaunchCast and ShoutCast.

The Internet radio aggregator may acquire the information from the Internet radio server 108 in a variety of different ways. For instance, the servers may simply forward the information to the aggregator over the network 106 on some periodic (e.g., hourly, daily) basis. Alternatively, the information may be included as metadata in the media content itself.

The Internet radio aggregator extracts the information from the metadata. The delivery mechanism for the metadata generally differs for different digital encoding formats. For instance, encoding formats such as MP3 and Windows Media Audio (WMA) utilize tags such as ID3 tags in the case of MP3 files. The precise manner in which the Internet radio aggregator acquires the information is not relevant to the systems and methods described herein and thus will not be discussed in more detail.

As previously mentioned, one problem with the use of an Internet radio aggregator is that the user must select content such as a song or program on a song by song or program or program basis. Once the user listens to the selected content item, subsequent items being streamed from that particular server may be of less interest to the user. In addition, each time the user wishes to hear a new item he or she must perform a new search. This can be time-consuming and inconvenient for the user and, further, does not allow the user to select different times at which he or she would like to receive different types of programming. For instance, the user may be interested in hearing certain genres of music in the morning and a different genre of music in the afternoon. As another example, the user may be interested in hearing a certain musical performer in the morning and a talk show on one or more desired topics in afternoon, followed later by a particular genre of music. Additionally, Internet radio aggregators do not allow the user to prioritize items of interest so that, for instance, if the user's first choice of musical performer is not being streamed, the user can receive his or her second choice of performer, if available.

To overcome these and other problems, a content scheduling module or application is provided in the client device. The content scheduling module or application allows the user to develop a profile of preferences using any of a variety of different criteria. Once the profile has been created by the user, the module performs a search through one or more of the Internet radio aggregators to find content items that match the criteria. The module then schedules the content items so that they will be received from their respective Internet radio servers at the appropriate time in accordance with the user's criteria established in the profile. The module may be configured as a stand-alone application that resides on the client device. For instance, in FIG. 2 the application may be stored as a program 607 on nonvolatile storage unit 605. Alternatively the application may be configured as a plug-in or extension to the client devices browser (e.g., browser 608 in FIG. 2) or media player (e.g., media player 609 in FIG. 2).

Instead of locating the content scheduling module on the client device, the module may be implemented as a service that is delivered to the client device over the network 106 in FIG. 1. That is, the module may be an example of so-called cloud computing in which a resource delivering the service is accessed by the client device over the Internet or other network. In this way the content scheduling module can serve multiple client devices simultaneously. In some cases the module may even be integrated with an Internet radio aggregator, thereby potentially enabling a simpler and more unified experience for the user.

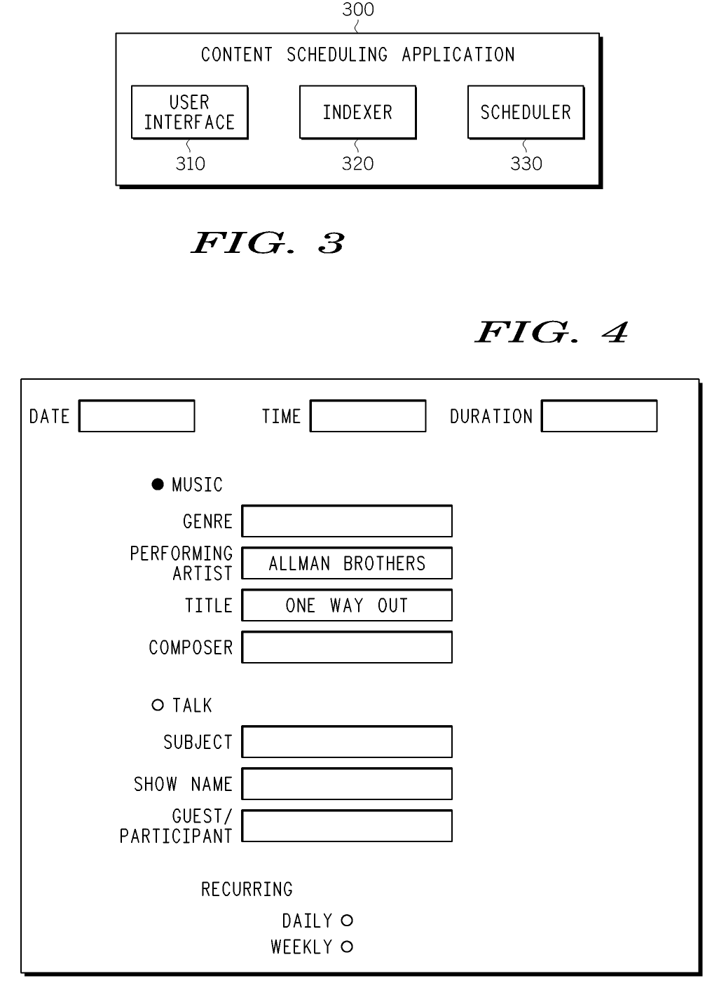

FIG. 3 shows one example of the functional elements that may be incorporated in the content scheduling module, which in this example is configured as an application 300 residing on the client device. The application 300 includes a user interface 310 through which the user establishes the content preference profile, an indexer 320 that tabulates and stores the search results obtained in accordance with the profile, and a scheduler 330 that selects and prioritizes the search results and, at the scheduled times, directs the client device's media player to access the designated URL or other address provided along with the search results. In this way the search application automatically schedules which Internet radio station is to be received and rendered at various times in accordance with the user's selections.

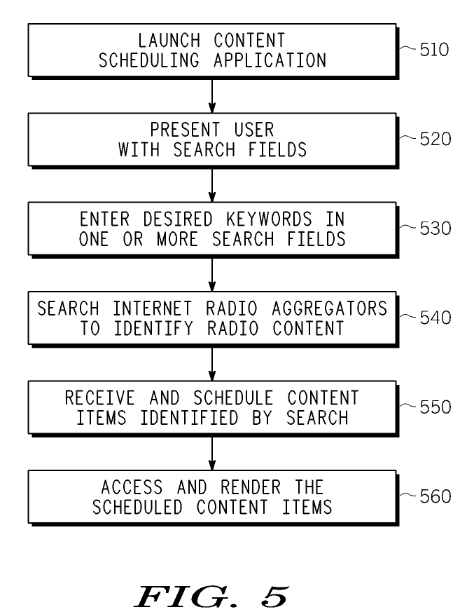

In the simplest case the content preference profile may consist of one or more keywords entered by the user through the user interface and a date and time at which programming including those keywords is to be rendered. Of course, more complex preference profiles may also be used to more accurately find content of interest to the user. FIG. 4 shows one example of a menu of options that may be presented to the user by the user interface 310 in order to create the profile. The menu illustratively includes fields that allow the user to search for music using one or more items such as genre, performing artist, title, and composer. The user may also search for talk programs using one or more items such as subject, show name, and the guest or other participants or commentators. In some implementations some or all of the fields may be filled in manually by the user and/or filled in by selecting from a pull-down menu of options associated with each field. For instance, in FIG. 4 the user has requested the song “One Way Out” by the Allman Brothers.

FIG. 5 is a flowchart showing one example of method by which a user creates a customized schedule of Internet radio programming that will be automatically streamed to a user on a PC or other client device on which a content scheduling application is located. The method begins in step 510 when the user launches the content scheduling application. The application presents the user in step 520 with a menu of search fields in which the user will enter keywords that will serve as criteria for identifying the desired content. The user enters the desired keywords in one of more of the search fields included in the menu in step 530. The information in the search fields completed by the user functions as a user profile. Once the application has received the user profile, it conducts a search in step 540 of one or more on-line databases such as the aforementioned Internet radio aggregators to identify Internet radio content items (e.g. audio files) that conform to the user profile. The radio items may be content that is currently being streamed or will be streamed by various Internet radio stations. Next, in step 550 the application receives the search results and uses them to establish a schedule for accessing the content items so that they will be streamed to the user's client device in accordance with the user profile. Finally, in step 560 the application directs the media player associated with the client device to access and render the content items in accordance with the schedule that has been established such as by switching to the URL or other address designated with the desired programming at the designated time of the desired program.

The steps of the processes described above, including but not limited to those shown in FIG. 5, may be implemented in a general, multi-purpose or single purpose processor. Such a processor will execute instructions, either at the assembly, compiled or machine-level, to perform that process. Those instructions can be written by one of ordinary skill in the art following the description provided herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), and/or packetized or non-packetized wireline or wireless transmission signals.

1. At least one computer-readable medium encoded with instructions which, when executed by a processor, performs a method including:
receiving a user profile specifying at least one criterion for identifying digital media content to be streamed to a user over a network by one or more media distribution systems;
searching an online database for selected media content that conforms to the user profile; and
accessing the selected media content so that it is streamed to the user over the network in conformance with the user profile.

2. The computer-readable medium of claim 1 wherein the media content is Internet radio programming.

3. The computer-readable medium of claim 1 wherein the online database is an Internet radio aggregator.

4. The computer-readable medium of claim 1 wherein the selected media content includes a plurality of selected content items and further comprising obtaining search results that include a network address for each server that is or will be streaming each of the selected content items.

5. The computer-readable medium of claim 4 further comprising accessing the selected content items by establishing communication with the servers at the network addresses provided in the search results.

6. The computer-readable medium of claim 4 wherein the selected media content includes a plurality of selected content items and further comprising scheduling each of the selected content items so that they are accessed and streamed to the user in accordance with a schedule set forth in the user profile.

7. The computer-readable medium of claim 1 wherein the online database is searched by a plug-in to a browser or a media player.

8. The computer-readable medium of claim 1 wherein the online database is searched by an extension to a browser or a media player.

9. The computer-readable medium of claim 1 further comprising presenting to the user a menu of fields in which keywords are to be entered by the user to create the user profile.

10. A client device, comprising:
a network interface for receiving media content streamed over a network;
a media player for rendering the media content; and
a content scheduling module configured to identify, schedule and access over the network selected media content items in accordance with a user profile,
wherein the content scheduling module is configured to search an online database to identify the selected media content that conforms to the user profile.

11. The client device of claim 10 wherein the network interface includes a broadband modem.

12. The client device of claim 10 wherein the content scheduling module includes a user interface for establishing the user profile.

13. The client device of claim 10 wherein the content scheduling module is a plug-in or extension to the media player.

14. The client device of claim 10 further comprising a browser for accessing over the network a media aggregator that is used by the content scheduling module to identify the selected media content items.

15. The client device of claim 10 wherein the media content is Internet radio programming.

16. At least one computer-readable medium encoded with instructions which, when executed by a processor, performs a method including:
receiving a plurality of user profiles from different users, wherein each user profile specifies at least one criterion for identifying digital media content to be streamed to a user over a network by one or more media distribution systems;
searching an online database to identify selected media content items that conform to each of the user profiles;
creating for each user a programming schedule scheduling a time at which each user's selected media content item will be streamed by its respective media distribution system; and
delivering the programming schedules to their respective users so that the content items can be streamed to the user over the network in conformance with the user profile.

17. The computer-readable medium of claim 16 wherein the programming schedules include for each content item a network identifier for accessing the media distribution system that streams the content item.

18. The computer-readable medium of claim 16 wherein the online database is maintained by an Internet radio aggregator.

19. The computer-readable medium of claim 18 wherein the receiving, searching, creating and delivering steps are performed by the Internet radio aggregator.
